(19) United States
(12) Patent Application Publication
(10) Pub. No.: US 2003/0157456 A1
(43) Pub. Date: Aug. 21, 2003

(54) Fiberoptic dental bleaching device and method of making bleaching device

(76) Inventor: John R. Plocharczyk, Enfield, CT (US)

Correspondence Address: CUMMINGS AND LOCKWOOD, GRANITE SQUARE, 700 STATE STREET, P O BOX 1960, NEW HAVEN, CT, 06509-1960, US

(21) Appl. No.: 10/372,571

(22) Filed: Feb. 21, 2003

Related U.S. Application Data
(60) Provisional application No. 60/358,559, filed on Feb. 21, 2002.

(51) Int. Cl. A61C 3/00

(52) U.S. Cl. 433/29

(57) ABSTRACT

A dental bleaching device is provided which is adapted to be used with a light source. The light source may be an existing dental light curing system, thereby permitting the existing light curing system to be used as dental bleaching system. The dental bleaching device comprises a glass core material and a cladding material having a lower refractive index than the core material, and a connector to connect the dental bleaching device to a light source. Methods of manufacturing the dental bleaching device are also provided.

This application claims priority to provisional application Serial No. 60/358,559 filed on Feb. 21, 2002.

### BACKGROUND OF THE INVENTION

Dental bleaching is a procedure performed by dental practitioners to whiten the teeth of patients. The dental bleaching treatment requires a high intensity light beam which can be focused on the patient's teeth. The light beam is used in combination with a peroxide gel or other bleaching substance applied to the teeth.

Current dental bleaching systems require dental practitioners to purchase expensive equipment, including a power supply, light source, light guide and peroxide gels or other bleaching substance for use with the light system. The light guide typically ends in a piece shaped to direct light to essentially all of the teeth in the patient's mouth.

Previous dental bleaching systems typically used light guides made of an acrylic material. These light guides cannot be autoclaved for sterilization because the heat of the autoclave can cause deformation of the light guide. Also, acrylic light guides do not transmit light efficiently. In addition, these dental bleaching systems are typically special purpose systems used exclusively for the dental bleaching procedure.

Many dentists have light curing systems in their offices that are used to cure epoxies or other materials used in restorative procedures. These light curing systems are typically designed to transmit light to only one or two teeth at a time. Accordingly, these light curing systems cannot be used efficiently or effectively to whiten teeth using the dental bleaching procedure.

Current light curing systems are generally of two types: (1) gun-type units and (2) base units with a flexible light guide extending from the base unit. Gun-type units typically include a light source (i.e. halogen bulb or laser), a power supply and a cooling fan, with a receptacle for connecting a fiber optic attachment to focus the light on a small number of teeth, often only a single tooth. Base units include a power supply and light source (typically an arc lamp or laser) connected by a flexible fiber optic or liquid light guide to a fiber optic output device.

It would be advantageous to have an output device which could be attached to existing light curing systems to allow the light curing systems to be used for dental bleaching procedures. In addition, it would be advantageous to have a dental bleaching device that can transmit light more efficiently than existing acrylic devices, and that could be autoclaved for sterilization.

Accordingly, it is an object of the present invention to provide a fiberoptic dental bleaching device that overcomes the drawbacks and disadvantages associated with acrylic bleaching devices and that allows existing light curing systems to be more efficiently used for dental bleaching.

### BRIEF DESCRIPTION OF THE DRAWINGS

So that those having ordinary skill in the art to which the subject invention appertains will more readily understand the subject invention, reference may be had to the drawings, wherein:

FIG. 1a is an overhead view of a dental bleaching device of the present invention.

FIG. 1b is a front view of the output end of a single element dental bleaching device.

FIG. 1c is a front view of the output end of a multi-array dental bleaching device.

FIG. 1d is a magnified view of area A in FIG. 1 c showing the individual fibers of the multi-array dental bleaching device.

FIG. 2 is an overhead view of a dental bleaching device with an adapter fixed to the light input end of the device for attaching the dental bleaching device to a light source.

FIG. 3 is a side view of the dental bleaching device of FIG. 2 with the adapter engaged in a corresponding receptacle in the output end of a gun-type light source.

FIG. 4 is a side view of the dental bleaching device of FIG. 2 with the dental bleaching device attached to a gun-type light source.

FIG. 5 is an overhead view of a dental bleaching device with an elongated adapter fixed to the input end of the device for attaching the dental bleaching device to the output end of a fiber optic light guide.

FIG. 6 is an overhead view of the dental bleaching device of FIG. 5 attached to the output end of a flexible light guide which is connected to a light source.

FIG. 7 is a side view of the dental bleaching device attached to an LED photocuring device.

FIG. 8a is an overhead view of a single element dental bleaching device.

FIG. 8b is an overhead view of a multi-array dental bleaching device.

### DETAILED DESCRIPTION OF PREFERRED EMBODIMENTS

The present invention relates to a fiberoptic dental bleaching device adapted to be used with existing light curing systems. The fiberoptic dental bleaching device may be comprised of a single element, or it may be a multi-array of fiber optic elements. A connecting means is fixed to the dental bleaching device that permits the device to be connected to an existing light curing system, thereby permitting the existing light curing system to be used as a dental bleaching system. The present invention also relates to methods of making the dental bleaching device. Because the dental bleaching device is made of glass, it can be placed in an autoclave for sterilization without adverse effects on its subsequent performance.

The dental bleaching device includes means for transmitting light from a light source to an area to be illuminated. The light transmission means comprises a light guide made of an inner glass core and an outer cladding or a plurality of glass fibers with each fiber comprising a glass core and an outer cladding. In preferred embodiments, the light transmission means is constructed and shaped as described below.

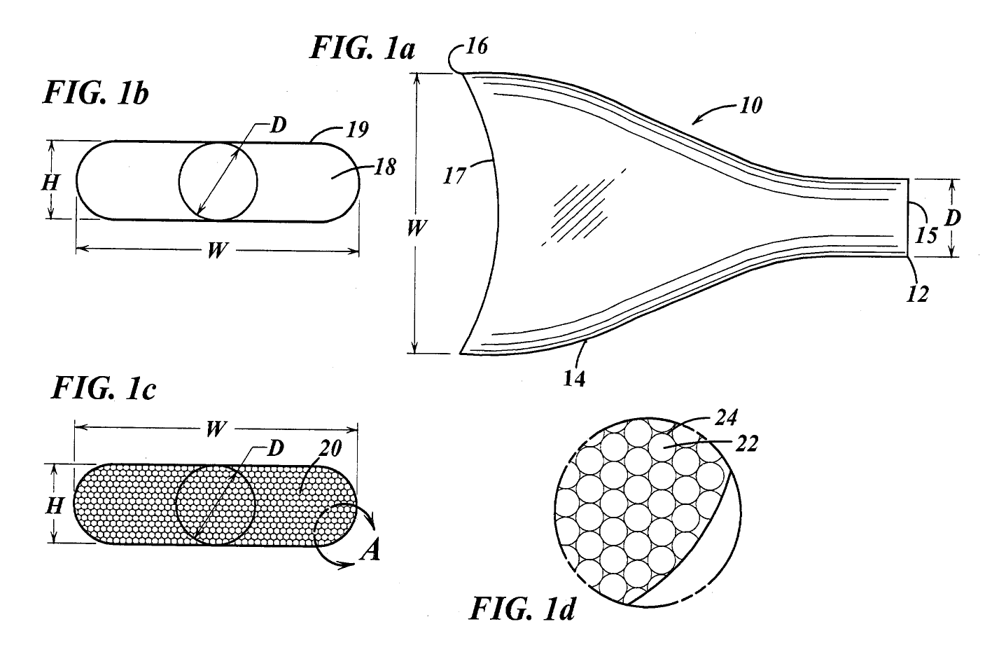

Referring to FIG. 1a, in one embodiment of the invention, the dental bleaching device, indicated generally by the reference number (10), has a cylindrically shaped input end (12) which has a diameter (D) that corresponds to the diameter of the light output end of a light curing system, such as the light output end of a gun-type curing device or the light output end of a light guide attached to a base. In a preferred embodiment, the diameter (D) of the input end is approximately 0.510 inches. The invention is not limited in this regard, however, and the diameter (D) of the input end (12) of the bleaching device can be any desired diameter appropriate for the intended use of the bleaching device.

The bleaching device has a transition portion (14) in which the width of the bleaching device gradually expands in the direction from the input end (12) towards the output end (16) of the bleaching device. As shown in FIG. 1b, preferably the height (H) of the bleaching device remains constant through the transition portion, and is approximately equal to the diameter (D) of the input end (12).

At the end of the transition portion (14), the bleaching device reaches a maximum width (W). The maximum width (W) is selected to allow a broad area of illumination of the mouth to provide light to illuminate essentially all of the teeth. In a preferred embodiment shown in FIGS. 1b and 1c, the maximum width (W) is approximately 1.875 inches. The invention is not limited in this regard, however, and the maximum width (W) of the bleaching device can be varied as desired to accommodate larger or smaller illumination areas.

As shown in FIGS. 1b and 1c, the height (H) of the output end (16) of the bleaching device is typically equal to the diameter (D) of the input end of the device. In a preferred embodiment, the height of the device is approximately 0.51 inches, which corresponds to a diameter typically used for attachments in light curing systems. The invention is not limited in this regard, and the height (H) of the output end (16) of the bleaching device may be any desired or appropriate dimension based upon the intended use of the device.

The face (15) of the input end (12) of the dental bleaching device may be flat, curved or faceted as desired to distribute the light entering the bleaching device from the light source. In a preferred embodiment, the face of the input end of the bleaching device has a V-shaped notch cut into the input end of the bleaching device. The depth of the V-shaped notch is preferably about 3/16 of an inch and the top of the notch is approximately as wide as the diameter of the input end. The V-shaped notch improves light transmission and minimizes hot spots that can form in the center portion of the input end of the device.

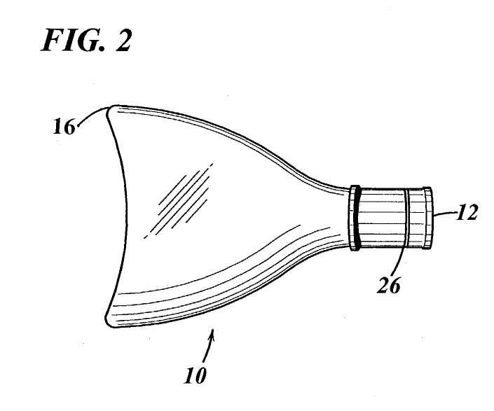

The face (17) of the output end (16) of the bleaching device may be flat, or it may be curved to better align with the shape of the mouth. As shown in FIGS. 1a and 2, the output end (16) of the bleaching device preferably has a concave curvature to better correspond to the curvature of the mouth. In an especially preferred embodiment, the bleaching device has a concave shape with a radius of about 2 inches. In use, the bleaching device may be held in close proximity to the teeth (e.g., about ⅛ of an inch away), and a concave curvature will increase the intensity of the light incident on the teeth.

The dental bleaching device may be comprised of a single element, or it may be composed of a multi-array of fiber optic elements. As shown in FIG. 1b, a single element bleaching device is comprised of a glass core material (18) covered by a cladding (19). The cladding (19) may be comprised of a single layer of one material, such as glass, or an inner cladding material and an outer cladding material, or a single cladding material and an outer coating. The cladding material is preferably glass, and is selected to have a refractive index lower than the refractive index of the core such that most of the light impinging upon the cladding is reflected back into the core material. This minimizes light losses from the bleaching device and increases the efficiency of the bleaching device in transmitting light. Outer coatings can be selected to impart desired properties to the bleaching device. Selection of materials having appropriate refractive indexes, and selection of appropriate outer coatings to impart desired properties, is well known to those skilled in the art.

As shown in FIGS. 1c and 1d, the multi-array dental bleaching device is comprised of a plurality of individual fiber optic elements (20). Each fiber optic element is comprised of a glass core (22) and a cladding (24). The cladding for the fiber optic elements can be comprised of any of the materials discussed above for the single element bleaching device, and is chosen to have a lower refractive index than the core material to reflect a large percentage of the light impinging on the cladding back into the core, minimizing losses of light and increasing the efficiency of light transmission. The outside of the multi-array bleaching device can be covered with a cladding material or coated as discussed above for the single element device.

Either the single element or the multi-array bleaching device may be enclosed in a housing comprised of plastic, metal or any other appropriate material known to those skilled in the art.

The faces (15, 17) of the output end (16) and the input end (12) of the bleaching device are ground and polished to the desired finish. For example, the input or output ends may be polished to an optical polish or they may have a matte finish depending upon the intended application of the device. The ends of the device may be coated to impart desired properties. For example, an anti-reflective coating or a filter coating may be applied to either end of the bleaching device. The invention is not limited in this regard, however, and any appropriate coating known to those skilled in the art may be applied to either end of the device to impart desired physical or optical properties.

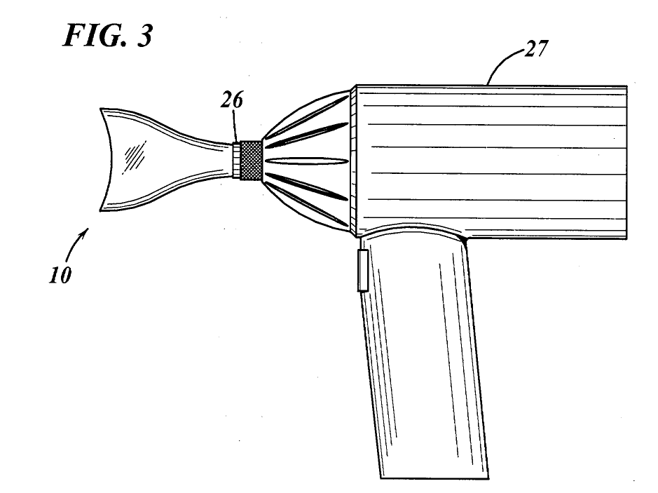

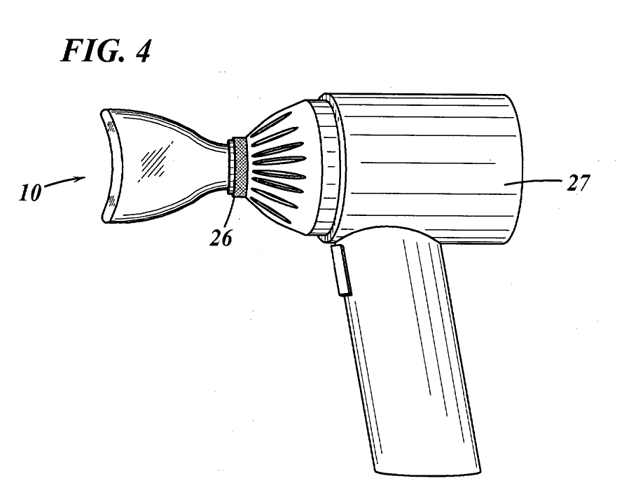

As shown in FIG. 2, the input end (12) of the dental bleaching device is coupled to connecting means (26) to allow the bleaching device to be connected to a light curing system. The connecting means (26) can be any appropriate type of adapter or connector known to those skilled in the art for connecting a light output device to a light curing system. The connecting means (26) is sized and shaped to be received in a corresponding adaptor or connector at the light output end of a light curing system. For example, the connector on the dental bleaching device shown in FIG. 2 is sized and shaped to be received and held in a gun-type light curing device (27) as shown in FIGS. 3 and 4.

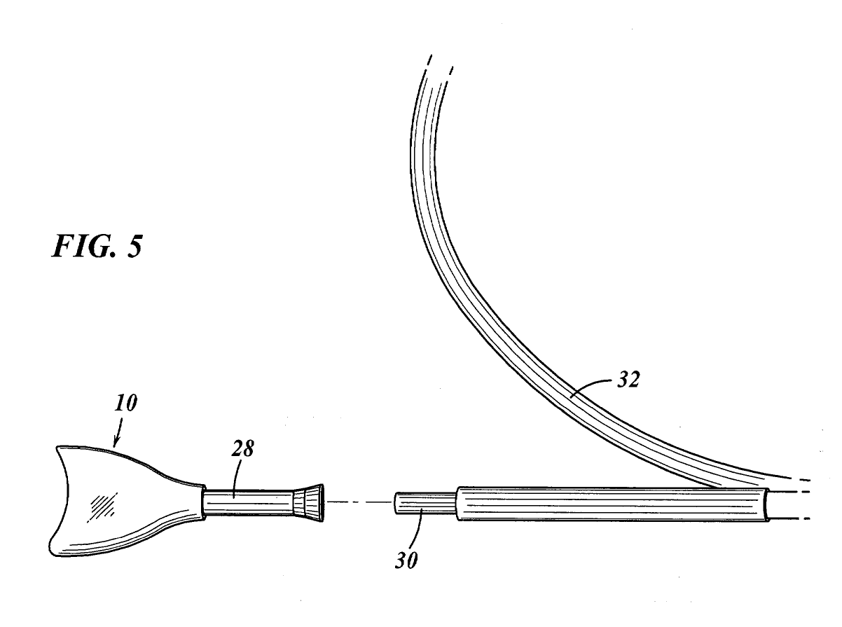

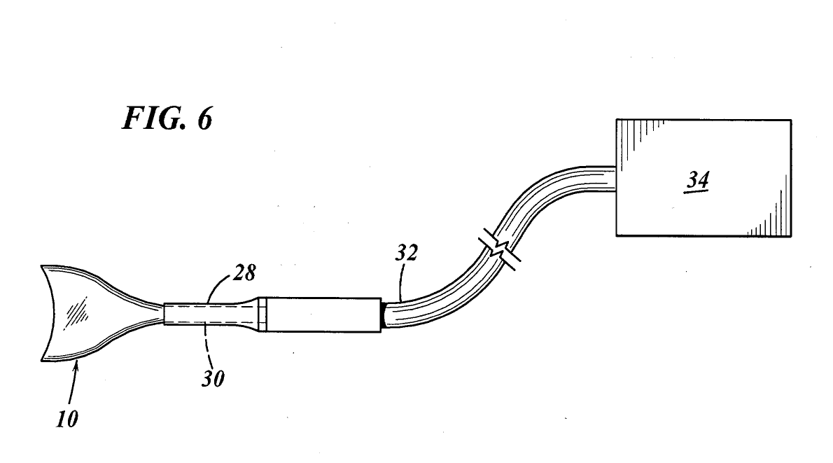

In another embodiment of the invention, shown in FIGS. 5 and 6, the dental bleaching device includes a connection device (28) which is sized and shaped to receive the light output end (30) of a fiber optic light guide (32) which is connected to a light source (34).

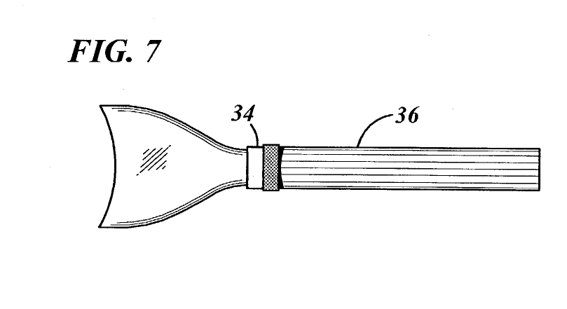

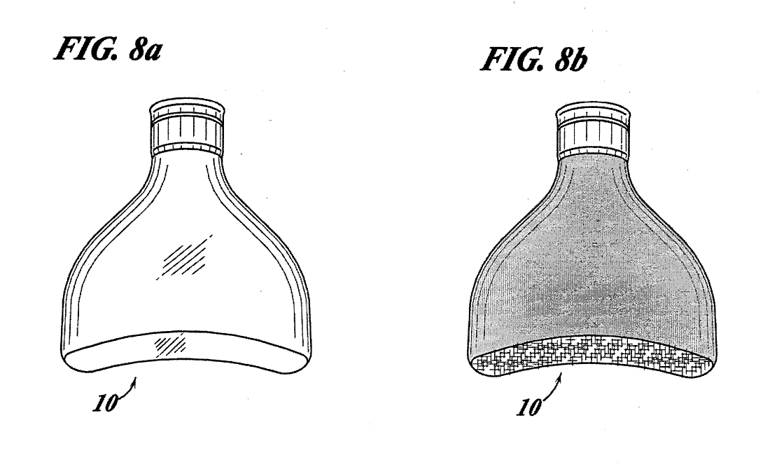

In yet another embodiment of the present invention, illustrated in FIG. 7, the dental bleaching device includes an adapter element (34) that is sized and shaped to be received in a correspondingly shaped receptacle in a portable LED photocuring device (36), such as the device described in U.S. Pat. No. 5,420,768 to Kennedy, the contents of which are incorporated herein in their entirety.

The device of the present invention can be used for dental bleaching procedures, and it can be used with existing base units used for light curing of epoxies or other materials used in dental reconstruction. The device may be used with any type of light source known to those skilled in the art, such as a light source with a fiber optic light guide, a light source with a liquid light guide, or it may be connected directly to the light source, as in a gun-type light curing device.

The method for manufacturing the dental bleaching device is as follows. A single element or multi-element fiberoptic billet or rod is made. The single element billet is made using a glass core material and a cladding material selected to provide the desired qualities in the dental bleaching device. The cladding material is preferably a glass having a lower refractive index than the core material to retain scattered light within the core material. The cladding material is preferably provided in a hollow cylindrical shape or envelope. The invention is not limited in this regard, however, and the cladding may be provided in any desired shape, or it may be coated or sprayed over the core and fired to bond to the core.

The core material is placed within the cladding material, and the core and cladding are heated to produce the single element billet. While they are heated, the core and cladding are pressed together or pulled together under a vacuum to create a clean, consistent interface between the core material and the cladding material. The single element billet is preferably cylindrical, and it may be of any desired diameter required to manufacture a bleaching device of the desired dimensions. In a preferred embodiment, the diameter of the billet is approximately 1.3 inches.

For a multi-array dental bleaching device, a billet may be formed using a plurality of small diameter glass fibers. The glass fibers are each comprised of a core material surrounded by a cladding material, preferably a glass cladding. The cladding material has a lower refractive index than the core material to reflect scattered light back into the core. A multi-array billet is made by packing the plurality of fibers into a glass envelope. The envelope and fibers are heated and pressed or pulled together under a vacuum to create a multi-array billet comprised of glass fibers. Alternatively, the individual fibers can be stacked in a mold and pressed together to form a block. The block can be machined into a billet or rod shape.

After the billet has been formed, the billet is heated and drawn into an hourglass shape or an elongated hourglass shape. The billet is drawn to create a tapered reduction in the diameter of the billet in the center portion of the hourglass shape. The billet is drawn until the center portion of the hourglass is reduced in diameter to the desired diameter for the input end of the device. When the drawing process is complete, the billet has two opposing cylindrical bases with diameters approximately equal to the starting diameter of the billet and a tapered region in which the diameter of the cylinder is gradually reduced to the desired diameter of the input end of the dental bleaching device. In a preferred embodiment, the starting diameter of the billet is approximately 1.3 inches and the diameter of the billet tapers to a center of approximately 0.510 inches.

The billet may also be heated and drawn to form an elongated hourglass shape. This is particularly preferred when the dental bleaching device will include an elongated shaft on the input end. In this embodiment of the invention, the billet is heated and drawn to create a cylindrical base with a diameter equal to the starting diameter of the billet, a tapered region in which the diameter of the billet is reduced to the desired diameter of the input end of the dental bleaching device, and an elongated region of constant diameter equal to the desired diameter of the input end of the dental bleaching device.

After the billet has been drawn to the desired hourglass shape, it may be cut in the center region to form two half hourglass shapes for molding into two dental bleaching devices. Alternatively, the billet may be drawn to form a half hourglass shape. In this embodiment of the method of the invention, the billet is drawn to form a tapered frustoconical shape, with the bottom of the half hourglass having a diameter approximately equal to the diameter of the billet prior to drawing and the top of the half hourglass having a diameter equal to the input end of the bleaching device.

After the glass billet has been drawn to the desired input end diameter, the output end of the billet is formed into the desired shape. If the billet has been drawn to an hourglass shape, the center portion can be cut before or after the output end has been molded to the desired shape. The larger diameter end of the drawn billet is pressed and heated to create the desired shape. In a preferred embodiment of the method, the faces of the press have milled recesses in the desired shape of the bleaching device, with each side having a recess equal to one half of the final height of the bleaching device. The recesses in the faces of the press form a mold in the press to form the desired shape. A milled stem section is also included for the input end of the bleaching device. The mold in the face of the press limits the deformation of the billet and creates the desired shape. The mold can be comprised of graphite, ceramic, maronite, steel, or any other appropriate material known to those skilled in the art.

As the larger diameter end of the drawn billet is being formed into the desired shape in the pressing process, the device can be dimpled or otherwise shaped or bent to obtain desired physical or optical properties. Alternatively, the device can be bent or shaped further after the pressing process using glass fiber shaping techniques known to those skilled in the art.

After the larger diameter end of the billet has been formed to the desired outer shape in the press, the face of the output end is cut to the desired shape. The output end of the bleaching device may be flat or curved either in a concave or convex shape. In a preferred embodiment, the output end has a concave shape corresponding to the shape of the mouth. After the face of the output end is cut to the desired shape, the face is ground and polished. The face of the output end can be polished to an optical polish or it can be given a matte finish depending upon the intended application for the device.

The face of the input end of the dental bleaching device is also cut to the desired shape. The face of the input end can be flat, convex, concave or faceted. A V-shaped notch may be cut in the face of the input end of the bleaching device to minimize hot spots that can form in the center portion of the input end. After the face of the input end is cut, the face is ground and polished. A coating can be applied to face of the input end if desired to enhance the properties of the device.

Connecting means, such as an adapter or connector, is fixed to the input end of the bleaching device. The connecting means is selected to permit the dental bleaching device to be connected to a light source of the desired type. Preferably, the adapter or connector can be connected to a light curing device. The adapter or connector can be fixed to the input end using any method known to those skilled in the art. Preferably, the adaptor or connector is glued to the input end of the bleaching device.

A shaft or extended input end can be added to the bleaching device if desired. An extension made of a compatible material can be fused to the bleaching device with heat if desired. Alternatively, an extension can be glued or mechanically attached to the bleaching device.

A housing or other type of protective covering can be fixed to the outer surface of the bleaching device. The housing can be made from plastic, metal or any other material known to those skilled in the art. Preferably, the housing is made from a material that can be autoclaved.

As will be recognized by those of ordinary skill in the art based on the teachings herein, numerous changes and modifications may be made to the above-described embodiments of the present invention without departing from its spirit or scope. Accordingly, this detailed description of preferred embodiments is to be taken in an illustrative rather than a limiting sense.

I claim:

1. A dental bleaching device for use with a light source having a first connector for connecting the dental bleaching device to the light source, comprising:
a light guide including a glass core and a cladding covering the outer surface of the glass core and having a lower refractive index than the glass core, wherein the light guide has a generally cylindrical input end having an input face for receiving light from a light source, and a tapered portion, wherein the width of the tapered portion increases with distance from the input end and the tapered portion terminates in an output end having an output face for transmitting light to an area to be illuminated; and
a second connector coupled to the input end of the light guide and connectable to the first connector for transmitting the light from the light source through the glass core of the bleaching device.

2. A dental bleaching device for use with a light source having a first connector for connecting the dental bleaching device to the light source, comprising: a light guide including a plurality of fiber optic elements, wherein each of the plurality of fiber optic elements comprises a glass core and a cladding material covering the outer surface of the glass core and having a lower refractive index than the glass core, a generally cylindrical input end having an input face for receiving light from a light source, and a tapered portion, wherein the width of the tapered portion increases with distance from the input end and the tapered portion terminates in an output end having an output face for transmitting light to an area to be illuminated; and
a second connector coupled to the input end of the light guide and connectable to the first connector for transmitting the light from the light source through the glass core of the bleaching device.

3. The dental bleaching device of claim 1, wherein the input end has a diameter of about 0.510 inches.

4. The dental bleaching device of claim 3, wherein the output end has a width of about 1.875 inches.

5. The dental bleaching device of claim 4, wherein the output end has a concave shape having a radius of about 2 inches.

6. The dental bleaching device of claim 2, wherein the input end has a diameter of about 0.510 inches.

7. The dental bleaching device of claim 6, wherein the output end has a width of about 1.875 inches.

8. The dental bleaching device of claim 7, wherein the output end has a concave shape having a radius of about 2 inches.

9. The dental bleaching device of claim 1, wherein the cladding is a glass having a lower refractive index than the glass core.

10. The dental bleaching device of claim 3, wherein the face of the input end is faceted.

11. The dental bleaching device of claim 1, further comprising an outer housing.

12. The dental bleaching device of claim 2, further comprising an outer housing.

13. A dental bleaching device for use with a light source, comprising:
means for connecting the dental bleaching device to the light source; and
means for transmitting light from the light source to an area to be illuminated.

14. A method for manufacturing a dental bleaching device, comprising the steps of:
(a) providing a glass core material and a cladding material having a lower refractive index than the core material;
(b) covering the outer surface of the glass core material with the cladding material;
(c) heating the glass core material and the cladding material while applying force to create a billet wherein the glass core material and the cladding material are bonded;
(d) heating and drawing the billet to create a tapered reduction in the diameter of the billet in the center portion of the billet to form an hourglass-like shape;
(e) cutting the billet in the center portion of the billet to create at least one tapered frustoconical portion;
(f) shaping the frustoconical portion to form a dental bleaching device having the desired shape;
(g) polishing the ends of the dental bleaching device; and
(h) fixing to one end of the dental bleaching device a connector adapted to be received by a light source.

15. The method of claim 14, wherein the step of shaping the frustoconical portion comprises heating and pressing the frustoconical portion in a press wherein the faces of the press have recesses forming a mold to shape the frustoconical portion.

16. The method of claim 14, further comprising the step of:
(i) fixing a housing to the outer surface of the dental bleaching device.

17. A method for manufacturing a dental bleaching device, comprising the steps of:
(a) providing a plurality of glass fibers, wherein each of the plurality of glass fibers comprise a glass core and a cladding having a lower refractive index than the glass core;
(b) filling a glass envelope with the plurality of glass fibers;
(c) heating and pressing the filled glass envelope to create a billet;
(d) heating and drawing the billet to create a tapered reduction in the diameter of the billet in the center portion of the billet to form an hourglass-like shape;
(e) cutting the billet in the center portion of the billet to create at least one tapered frustoconical portions;
(f) shaping the frustoconical portion to form a dental bleaching device having the desired shape;
(g) polishing the ends of the dental bleaching device; and
(h) fixing to one end of the dental bleaching device a connector adapted to be received by a light source.

18. The method of claim 17, further comprising the step of:
(i) fixing a housing to the outer surface of the dental bleaching device.
